(19) United States
(12) Patent Application Publication
(10) Pub. No.: US 2008/0119689 A1
(43) Pub. Date: May 22, 2008

(54) Rocker apparatus

(76) Inventor: Georgianna Reid, Kansas City, MO (US)

Correspondence Address: John C. McMahon, PO Box 30069, Kansas City, MO, 64112, US

(21) Appl. No.: 11/982,994

(22) Filed: Nov. 6, 2007

Related U.S. Application Data
(60) Provisional application No. 60/860,751, filed on Nov. 22, 2006.

(51) Int. Cl. A61H 19/00; A47C 7/62

(52) U.S. Cl. 600/38; 297/217.1

(57) ABSTRACT

A sexual aide apparatus comprising a wicker rocking chair with a simulated male member frictionally held by wicker in a front panel of the char and a method of using the apparatus.

### CROSS REFERENCE TO RELATED APPLICATION

This application claims the benefit of U.S. Provisional Application No. 60/860,751, filed Nov. 22, 2006 and incorporated by reference herein.

### BACKGROUND OF THE INVENTION

The present invention is directed to a wicker chair apparatus with an attached sexual or marital aide and a method of use.

Many women find that a sexual partner is not available to them or is undesired for some reason. For such women that still want to enjoy sexual activity, the apparatuses that are available for use without partners all have drawbacks that make them hard to use, very expensive and/or unsatisfying for some other reason.

### SUMMARY OF THE INVENTION

The present invention is directed to a marital aide apparatus for use by women. The apparatus includes a wicker rocker chair with a diagonally woven pattern of spaced wicker strands located throughout the chair and especially located on a vertical front panel extending downwardly from a seat and between the front legs. A simulated male member or dildo is captured between crossing strands of the front panel at a height selected by the user. Use of the apparatus physically works the muscles of the lower body, while leaving the hands free.

The apparatus is used by the user lying on their back with their legs located on the chair and with the member sexually inserted into the user. The user then rocks the chair using their legs so that the member reciprocates within them at a speed determined by the user which can be changed between sessions or during a single session.

### OBJECTS AND ADVANTAGES OF THE INVENTION

Therefore, the objects of the present invention are: to provide a sexual aide apparatus that comprises a wicker rocking chair and a simulated male member that can be inserted in the wicker lattice of a front panel of the chair and held snugly by the lattice; to provide such an apparatus that has components that can be easily acquired and assembled, as well as disassembled, so the chair can be functionally used as a seat; to provide such an apparatus that can easily be used by a woman for sexual activity; to provide such an apparatus that also provides physical conditioning while leaving the hands free; and to provide such an apparatus that is inexpensive, easy to produce and particularly well adapted for the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a chair apparatus according to the present invention.

FIG. 2 is a partially fragmentary view of the chair apparatus in use.

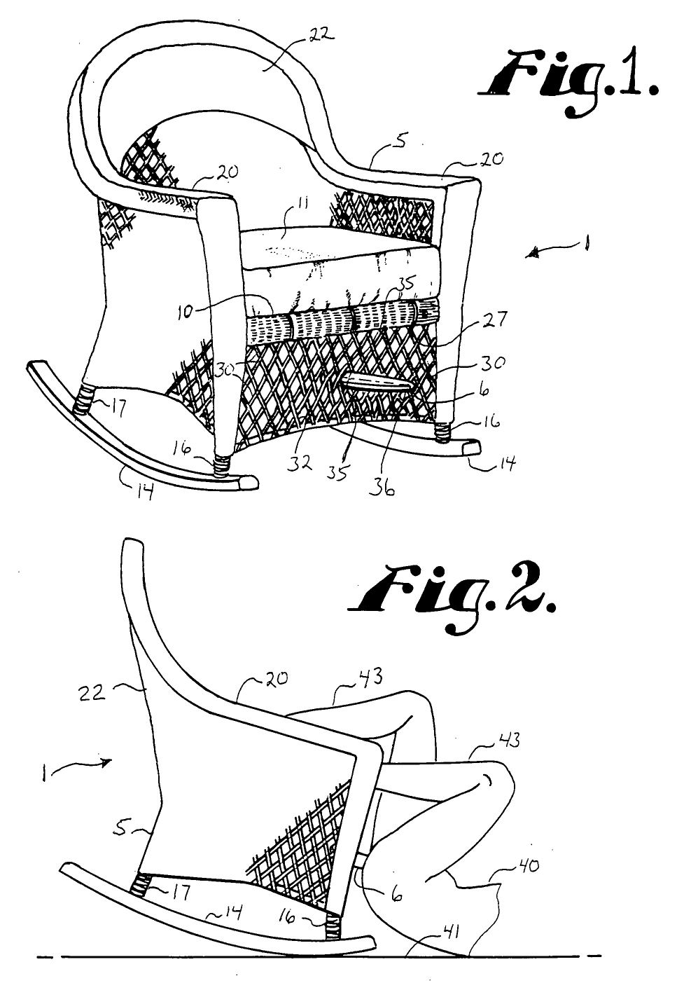

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference numeral 1 generally represents a sexual apparatus according to the present invention. The apparatus 1 comprises a wicker rocking chair 5 in combination with a dildo or artificial male member 6.

The chair 5 has a seat 10 supporting a cushion 11 which is in turn supported on a pair of rockers 14 by a pair of front legs 16 and a pair of rear legs 17. A pair of arm rests 20 extends up from the sides of the chair 5 and merge or join with a rear portion to form a back 22.

Extending downward from the seat 10 and located between the front legs 16 is a front panel 27 formed of a plurality of spaced and crisscrossed wicker strips 30. The strips 30 are generally evenly spaced and oriented so as to form a diamond pattern 32 therebetween. The strips 30 are stiff and the diamond pattern 32 is slightly flexible, but resilient in trying to return to its original pattern.

The member 6 is elongate and rigid or stiff. Preferably, the member is constructed of a soft and pliable material such as rubber or the like. The member 6 is also preferably double long or extra long, both to allow for adjustment to suit the user and to provide sufficient rearward length to be gripped by the chair 5, as described below. The member 6 could include a vibrator, but is preferably without such.

The member 6 is placed at a preferred location in the front panel 27 with a rear end 35 inserted into and stuck between two crossing pairs of the wicker strands 30 and preferably extending substantially behind the panel 27 to maintain grip and stability. The strands 30 can be spread somewhat by application of force and thereafter frictionally hold the member snug in place with a front end 36 of the member 6 protruding forward of the front panel 127.

In use, a user 40 places herself on a floor 41 in front of the chair 5 with her legs 43 supported by the seat 10 or alternatively the arm rests 20. The member 6 is allowed to penetrate her vaginally. The woman 40 thereafter rocks the chair 5 using her legs 43, so as to reciprocate the member 6 at the speed desired by the woman 40, which can be varied over time.

It is to be understood that while certain forms of the present invention have been illustrated and described herein, it is not to be limited to the specific forms or arrangement of parts described and shown.

What is claimed and desired to be secured by Letters Patent is as follows:

1. In combination; a wicker rocking chair having a front panel that is constructed of crisscrossed wicker strands and a simulated male member implanted between a selected group of said strands so as to be held by friction and such that said member extends forward of the chair.

2. A method of performing sexual activity including the steps of; providing a wicker rocking chair with a front wicker panel, frictionally embedding a rear end of a simulated male member in the front panel so as to be frictionally held by wicker in the front panel, positioning a person on their back in front of the chair with feet of the person on the chair and the member implanted sexually within the person, and using legs of the person to rock the chair and move the member back and forth.
